(19) United States
(12) Patent Application Publication
(10) Pub. No.: US 2024/0054506 A1
(43) Pub. Date: Feb. 15, 2024

(54) CORPORATE NUMBER AND CORPORATE CODE MANAGEMENT METHOD, AND CORPORATE NUMBER AND CORPORATE CODE MANAGEMENT TERMINAL APPARATUS

(71) Applicant: Jinqian HU, Hangzhou (CN)

(72) Inventor: Jinqian HU, Hangzhou (CN)

(21) Appl. No.: 18/494,560

(22) Filed: Oct. 25, 2023

Related U.S. Application Data
(63) Continuation of application No. PCT/CN2022/086242, filed on Apr. 12, 2022.

(30) Foreign Application Priority Data
Apr. 26, 2021 (CN) 202110488658.1

(51) Int. Cl. G06Q 30/018; G06F 21/32

(52) U.S. Cl. CPC G06Q 30/018; G06F 21/32

(57) ABSTRACT

A corporate number and corporate code management method comprises: acquiring a plurality of identity information of a corporate administrator of a corporate user, a plurality of corporate information, and a corporate number; authenticating the plurality of identity information and the plurality of corporate information to generate a plurality of authenticated identity information and a plurality of authenticated corporate information; matching and binding the plurality of authenticated identity information and the plurality of authenticated corporate information with the corporate number, and generating a corporate number and corporate code in a form of two-dimensional code; generating a legal person electronic personal seal according to the plurality of authenticated identity information; generating an electronic official seal and a plurality of business-specific seals according to the plurality of authenticated identity information and the plurality of authenticated corporate information; and configuring a business authority to a business agent according to a business application range.

### CROSS-REFERENCE TO RELATED APPLICATIONS

This application is a continuation of International Patent Application No. PCT/CN2022/086242 with a filing date of Apr. 12, 2022, designating the United States, now pending, and further claims priority to Chinese Patent Application No. 202110488658.1 with a filing date of Apr. 26, 2021. The content of the aforementioned applications, including any intervening amendments thereto, are incorporated herein by reference.

### TECHNICAL FIELD

The present invention relates to the technical field of information security, and in particular, to a corporate code management method and a corporate code management terminal apparatus.

### BACKGROUND OF THE PRESENT INVENTION

A ‘corporate code’ is a green channel for a corporate to obtain government businesses, an industrial-cooperative collaborative platform, and a data-driven application system comprehensive platform. However, in actual business activities of a corporate unit, a large amount of daily affairs are usually not directly operated by a legal person, but are handled and replaced by some departments of the corporate. In medium and large-scale corporates, the division of responsibilities among departments is meticulous, so the “corporate code” can only be registered and used by legal persons, which is difficult to meet the actual application needs of the corporate units, resulting in limited application and promotion of the corporate codes.

Therefore, it is urgent for those skilled in the art to develop an application business mode authorized by business agents on the basis of the application of the original “corporate code”, as well as a more convenient corporate number and corporate code management method as well as a corporate number and corporate code management terminal apparatus, so as to solve the troubles of the corporates in the management and application of the corporate numbers and corporate codes and meet the actual needs of daily government affair applications of the corporates.

It should be noted that the above description of the background is merely illustrative of a clear and complete description of the technical solutions of the present invention, and is convenient for those skilled in the art to understand. The foregoing technical solutions cannot be considered as well known to those skilled in the art because these solutions are set forth in the background section of the present invention.

### SUMMARY OF THE PRESENT INVENTION

In order to overcome the defects in the prior art, the embodiments of the present invention provide a corporate number and corporate code management method and a corporate number and corporate code management terminal apparatus.

The embodiments of the present application provide a corporate number and corporate code management method, specifically including the following steps of: acquiring a plurality of identity information of a corporate administrator of a corporate user, and acquiring a plurality of corporate information and a corporate number of the corporate user; performing entity or digital authentication on the plurality of identity information and the plurality of corporate information to generate a plurality of authenticated identity information and a plurality of authenticated corporate information; matching and binding the plurality of authenticated identity information and the plurality of authenticated corporate information with the corporate number of the corporate user, and generating a corporate number and corporate code in a form of two-dimensional code according to the corporate number of the corporate user; generating a legal person electronic personal seal according to the plurality of authenticated identity information; generating an electronic official seal and a plurality of business-specific seals according to the plurality of authenticated identity information and the plurality of authenticated corporate information; and configuring a business authority to a business agent according to a business application range, the business agent calling the electronic official seal and the plurality of business-specific seals in the business application range by means of the business authority.

Further, the method further comprises: performing real-name authentication on the business agent, and generating a business agent private seal after the real-name authentication.

Further, the plurality of business-specific seals comprise an invoice-specific seal, a financing-specific seal, a contract-specific seal and the like.

Further, the method further comprises: scanning the corporate number and corporate code through a two-dimensional code scanner of a mobile phone; and after scanning the code, the mobile phone automatically linking to a page, and the page displaying a plurality of project blocks for the business agent to click, and the plurality of project blocks respectively corresponding to a plurality of links of a plurality of businesses.

Further, the method further comprises: when the business agent clicks a specific project block of the plurality of project blocks, displaying a prompt message to remind the business agent to input a biometric datum; judging whether the specific project block clicked by the business agent belongs to the business application range, and judging whether the biometric data input by the business agent are consistent with a registered biometric datum for authentication; when the specific project block clicked by the business agent belongs to the business application range, and the biometric data input by the business agent are consistent with the registered biometric datum, allowing the business agent to call the electronic official seal and the plurality of business-specific seals in the business application range by means of the business authority; and when the specific project block clicked by the business agent does not belong to the business application range, or the biometric data input by the business agent are not consistent with the registered biometric datum, prohibiting the business agent from calling the electronic official seal and the plurality of business-specific seals in the business application range by means of the business authority.

Further, the method further comprises: when the specific project block clicked by the business agent is a project block corresponding to an invoice issuing business and passes the authentication, allowing the business agent to call the electronic official seal and the invoice-special seal; and issuing an electronic invoice according to the electronic official seal, the invoice-specific seal and the business agent private seal of the business agent.

Further, the method further comprises: when the specific project block clicked by the business agent is a project block corresponding to a contract signing business and passes the authentication, allowing the business agent to call the electronic official seal and the contract-specific seal; signing an electronic contract according to the electronic official seal, the contract-specific seal and the business agent private seal of the business agent.

Further, the method further comprises: providing a central control module, and a communication module, an identity authentication module, a key module and a storage module connected with the central control module; using the communication module to realize communication between the corporate user and an external server; using the identity authentication module to authenticate biometric data input by the corporate administrator and the business agent of the corporate user, and authorize the corporate administrator and the business agent of the corporate user after passing the authentication; using the key module to store a plurality of keys, and encrypt the plurality of authenticated identity information and the plurality of authenticated corporate information according to corresponding keys in the plurality of keys to generate a plurality of encrypted authenticated identity information and a plurality of encrypted authenticated corporate information; using the storage module to store the registered biometric data of the corporate administrator and the business agent of the corporate user, the plurality of encrypted authenticated identity information, the plurality of encrypted authenticated corporate information, the corporate number, the legal person electronic personal seal, the electronic official seal, the plurality of business-specific seals and the business agent private seal; and using the central control module to receive, input and control operations of other modules, and after the corporate administrator and the business agent of the corporate user are authorized, allow the corporate administrator and the business agent of the corporate user to call the electronic official seal and the plurality of business-specific seals in the business application range by means of the business authority.

Further, the plurality of corporate information comprise a bound bank account number, an electronic business license, tax control information, an official seal number, a legal person certificate number, a social credit code and/or an electronic license number of the corporate user authorized by a banking system and/or a government system.

Further, the corporate number comprises a mailbox number, a payment number, a cloud number, a video number and/or a fixed telephone number.

The embodiments of the present application further provide a corporate number and corporate code management terminal apparatus, comprising: a first capture module, a second capture module, an information authentication module, a corporate number and corporate code generation module, a legal person electronic personal seal generation module, an electronic official seal and business-specific seal generation module, and an authorization module. The first capture module is used for acquiring a plurality of identity information of a corporate administrator of a corporate user. The second capture module is used for acquiring a plurality of corporate information and a corporate number of the corporate user. The information authentication module is used for performing entity or digital authentication on the plurality of identity information and the plurality of corporate information to generate a plurality of authenticated identity information and a plurality of authenticated corporate information. The corporate number and corporate code generation module is used for matching and binding the plurality of authenticated identity information and the plurality of authenticated corporate information with the corporate number of the corporate user, and generating a corporate number and corporate code in a form of two-dimensional code according to the corporate number of the corporate user. The legal person electronic personal seal generation module is used for generating a legal person electronic personal seal according to the plurality of authenticated identity information. The electronic official seal and business-specific seal generation module is used for generating an electronic official seal and a plurality of business-specific seals according to the plurality of authenticated identity information and the plurality of authenticated corporate information. The authorization module is used for configuring a business authority to a business agent according to a business application range, the business agent calling the electronic official seal and the plurality of business-specific seals in the business application range by means of the business authority.

Further, the corporate number and corporate code management terminal apparatus further comprises: a business agent private seal generation module coupled to the authorization module and used for performing real-name authentication on the business agent, and generating a business agent private seal after the real-name authentication.

Further, the corporate number and corporate code management terminal apparatus further comprises: a central control module and a communication module, an identity authentication module, a key module and a storage module connected with the central control module. The communication module is used for realizing communication between the corporate user and an external server. The identity authentication module is used for authenticating biometric data input by the corporate administrator and the business agent of the corporate user, and authorizing the corporate administrator and the business agent of the corporate user after passing the authentication. The key module is used for storing a plurality of keys, and encrypting the plurality of authenticated identity information and the plurality of authenticated corporate information according to corresponding keys in the plurality of keys to generate a plurality of encrypted authenticated identity information and a plurality of encrypted authenticated corporate information. The storage module is used for storing the registered biometric data of the corporate administrator and the business agent of the corporate user, the plurality of encrypted authenticated identity information, the plurality of encrypted authenticated corporate information, the corporate number, the corporate number and corporate code, the legal person electronic personal seal, the electronic official seal, the plurality of business-specific seals and the business agent private seal, and the like. The central control module is used for receiving, inputting and controlling operations of other modules, and after the corporate administrator and the business agent of the corporate user are authorized, allow the corporate administrator and the business agent of the corporate user to call the electronic official seal and the plurality of business-specific seals in the business application range by means of the business authority.

By means of the above technical solutions, the beneficial effects of the invention are as follows: compared with the prior art, the corporate number and corporate code management method and the corporate number and corporate code management terminal apparatus provided by the present invention expand the application business mode authorized by the business agent on the basis of the application of the original “corporate code”, not only can meet the actual demands of the daily government affair application of the corporate, but also can enable more corporate employees to directly, conveniently and efficiently use the corporate number and corporate code, which achieves an effective mode for quickly handling the government affair business of the corporate, and meanwhile, promotes and popularizes an application breadth and depth of the corporate number and corporate code more widely.

### DESCRIPTION OF THE DRAWINGS

FIG. 1 is a frame diagram of a corporate number and corporate code management terminal apparatus in an embodiment of the present invention.

FIG. 2 is a frame diagram of a multi-module in FIG. 1.

FIG. 3 is a schematic diagram of a page providing a business agent of a corporate user to select a project block.

FIG. 4 is a schematic diagram of an operation example of an authorization module in the present invention.

FIG. 5 is a flow chart of a corporate number and corporate code management method in a first embodiment of the present invention.

FIG. 6 is a flow chart of a corporate number and corporate code management method in a second embodiment of the present invention.

FIG. 7 is a flow chart of a corporate number and corporate code management method in a third embodiment of the present invention.

### REFERENCE NUMERALS OF THE ABOVE DRAWINGS

10 refers to corporate number and corporate code management terminal apparatus; 110 refers to first capture module; 120 refers to second capture module; 130 refers to information authentication module; 140 refers to corporate number and corporate code generation module; 150 refers to legal person electronic personal seal generation module; 160 refers to electronic official seal and business-specific seal generation module; 170 refers to authorization module; 180 refers to business agent private seal generation module; 200 refers to multi-module; 210 refers to central control module; 220 refers to communication module; 230 refers to identity authentication module; 240 refers to key module; 250 refers to storage module; ID1-IDn refer to identity information; a1D1-a1Dn refer to authenticated identity information; Cl1-CIm refer to corporate information; aCI1-aCIm refers to authenticated corporate information; CN refers to corporate number; CC_Code refers to corporate number and corporate code; EPS refers to legal person electronic personal seal; ECS refers to electronic official seal; BS1-BSp refer to business-specific seals; BAS refers to business agent private seal; IB1-IB3 refer to project block; and S510-S570, S610-S660 and S710-S760 refer to steps.

### DETAILED DESCRIPTION OF PREFERRED EMBODIMENTS

To make the above and other objects, features and advantages of the present invention more obvious and easier to understand, the preferred embodiments will be described in detail below in conjunction with the attached drawings.

In order to illustrate the technical solutions in the embodiments of the present invention or in the related art more clearly, the drawings used in the description of the embodiments or the prior art will be briefly described below. Obviously, the drawings in the following description are merely some embodiments recorded in the present invention. For those of ordinary skills in the art, other drawings may also be obtained based on these drawings without going through any creative work.

The following clearly and completely describes the technical solutions in the embodiments of the present invention with reference to the drawings in the embodiments of the present invention. Apparently, the described embodiments are merely some but not all of the embodiments of the present invention. Based on the embodiments of the present invention, all other embodiments obtained by those of ordinary skills in the art without going through any creative work shall fall within the protection scope of the present invention.

It should be noted that in the description of the present invention, the terms ‘first’ and ‘second’ are used for descriptive purposes and distinguish similar objects only, and there is no sequence between the two, nor can it be understood as indicating or implying relative importance. In addition, in the description of the present invention, the meaning of “multiple” is two or more than two, unless otherwise specifically defined.

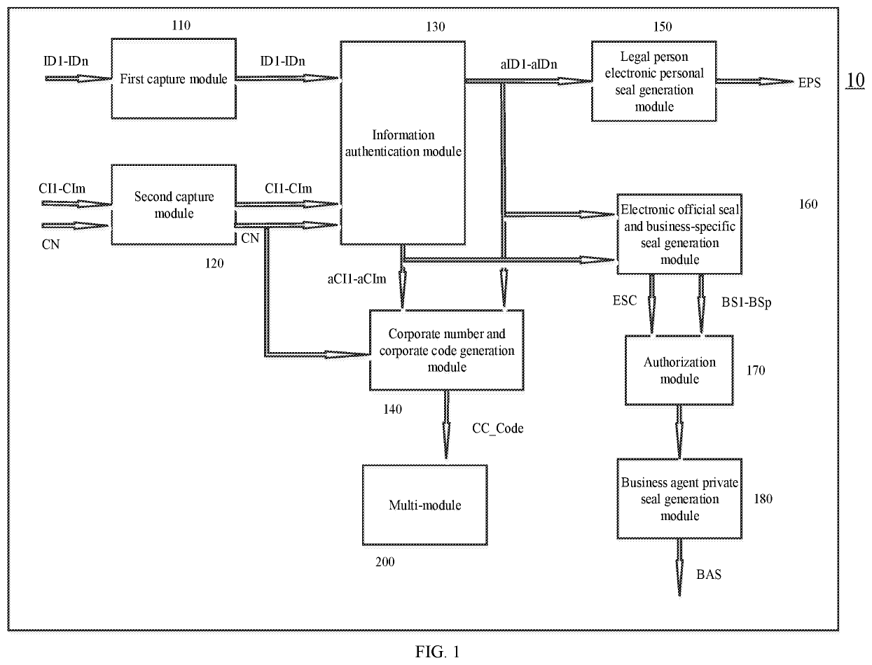

Referring to FIG. 1, FIG. 1 is a frame diagram of a corporate number and corporate code management terminal apparatus 10 in an embodiment of the present invention. As shown in FIG. 1, the corporate number and corporate code management terminal apparatus 10 comprises a first capture module 110, a second capture module 120, an information authentication module 130, a corporate number and corporate code generation module 140, a legal person electronic personal seal generation module 150, an electronic official seal and business-specific seal generation module 160, an authorization module 170 and a business agent private seal generation module 180. The first capture module 110 is used for acquiring a plurality of identity information ID1-IDn of a corporate administrator of a corporate user. The second capture module 120 is used for acquiring a plurality of corporate information Cl1-CIm and a corporate number CN of the corporate user. The information authentication module 130 is coupled to the first capture module 110 and the second capture module 120 and used for performing entity or digital authentication on the plurality of identity information ID1-IDn and the plurality of corporate information Cl1-CIm to generate a plurality of authenticated identity information a1D1-a1Dn and a plurality of authenticated corporate information aCI1-aCIm. The corporate number and corporate code generation module 140 is coupled to the information authentication module 130 and used for matching and binding the plurality of authenticated identity information a1D1-a1Dn and the plurality of authenticated corporate information aCI1-aCIm with the corporate number CN of the corporate user, and generating a corporate number and corporate code CC_Code in a form of two-dimensional code according to the corporate number CN of the corporate user. The legal person electronic personal seal generation module 150 is coupled to the information authentication module 130 and used for generating a legal person electronic personal seal EPS according to the plurality of authenticated identity information a1D1-a1Dn. The electronic official seal and business-specific seal generation module 160 is coupled to the information authentication module 130 and used for generating an electronic official seal ECS and a plurality of business-specific seals BS1-BSp according to the plurality of authenticated identity information a1D1-a1Dn and the plurality of authenticated corporate information aCI1-aCIm. The authorization module 170 is coupled to the electronic official seal and business-specific seal generation module 160 and used for configuring a business authority to a business agent according to a business application range, the business agent calling the electronic official seal ECS and the plurality of business-specific seals BS1-BSp in the business application range by means of the business authority. The business agent private seal generation module 180 is coupled to the authorization module 170 and used for performing real-name authentication on the business agent, and generating a business agent private seal BAS after the real-name authentication.

Please note that the plurality of identity information ID1-IDn may comprise an ID card, an address, a number number, a telephone number and/or a video number of a company founder (i.e., the corporate administrator of the corporate user), but the present invention is not limited to this.

In an embodiment, after completing the entity or digital authentication on the plurality of identity information ID1-IDn and the plurality of corporate information Cl1-CIm, the information authentication module 130 may send a digital protocol to the corresponding external server, and then generate the plurality of authenticated identity information a1D1-a1Dn and the plurality of authenticated corporate information aCI1-aCIm. Next, the corporate number and corporate code generation module 140 may first verify whether the plurality of authenticated corporate information aCI1-aCIm of the company founder of the corporate user and the plurality of authenticated corporate information aCI1-aCIm are matched with the corporate number CN of the corporate user. When the matching is successful, the corporate number and corporate code generation module 140 may generate the corporate number and corporate code CC_Code in the form of two-dimensional code according to the corporate number CN of the corporate user. In this way, the corporate user successfully registers the company on the corporate number and corporate code management terminal apparatus. In this case, the corporate user can not only generate the corporate code CC_Code in the form of two-dimensional code, but also has the electronic official seal, the certificate and the mailbox of the corporate, and automatically completes the registration of the legal person electronic personal seal.

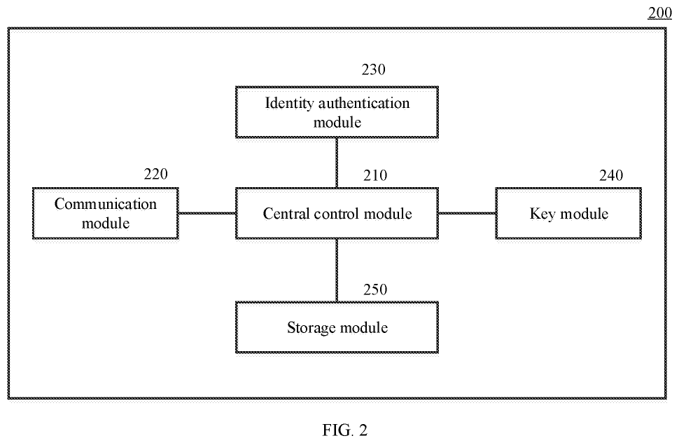

Referring to FIG. 1 and FIG. 2, the corporate number and corporate code management terminal apparatus 10 further comprises a multi-module 200. As shown in FIG. 2, the multi-module 200 comprises a central control module 210, and a communication module 220, an identity authentication module 230, a key module 240 and a storage module 250 connected with the central control module 210. The communication module 220 is used for realizing communication between the corporate user and an external server. The identity authentication module 230 is used for authenticating biometric data input by the corporate administrator and the business agent of the corporate user, and authorizing the corporate administrator and the business agent of the corporate user after passing the authentication. The key module 240 is used for storing a plurality of keys, and encrypting the plurality of authenticated identity information a1D1-a1Dn and the plurality of authenticated corporate information aCI1-aCIm according to corresponding keys in the plurality of keys to generate a plurality of encrypted authenticated identity information and a plurality of encrypted authenticated corporate information. The storage module 250 is used for storing the registered biometric data of the corporate administrator and the business agent of the corporate user, the plurality of encrypted authenticated identity information, the plurality of encrypted authenticated corporate information, the corporate number CN, the corporate number and corporate code CC_Code, the legal person electronic personal seal EPS, the electronic official seal ECS, the plurality of business-specific seals BS1-BSp and the business agent private seal BAS. The central control module 210 is used for receiving, inputting and controlling operations of other modules 220-250, and after the corporate administrator and the business agent of the corporate user are authorized, allowing the corporate administrator and the business agent of the corporate user to call the electronic official seal ECS and the plurality of business-specific seals BS1-BSp in the business application range by means of the business authority.

Further, the communication module 220 may comprise: at least one of a 3G communication module, a 4G communication module, a 5G communication module, a WIFI module, an NBIoT module, a Bluetooth module, an NFC module and an infrared module. The communication module 220 supports IPV4 and IPV6 protocols.

Please note that the plurality of corporate information Cl1-CIm may comprise a bound bank account number, an electronic business license, tax control information, an official seal number, a legal person certificate number, a social credit code and/or an electronic license number of the corporate user authorized by a banking system and/or a government system, but the present application is not limited thereto.

Please note again the corporate number CN may comprise a mailbox number, a payment number, a cloud number, a video number and/or a fixed telephone number, but the present application is not limited thereto. In other words, any number and code (comprising signature and key authentication) of the corporate user can be accessed. In practice, whether the number and code are accessed or not may be decided by the examination and approval authority of the corporate or a competent department.

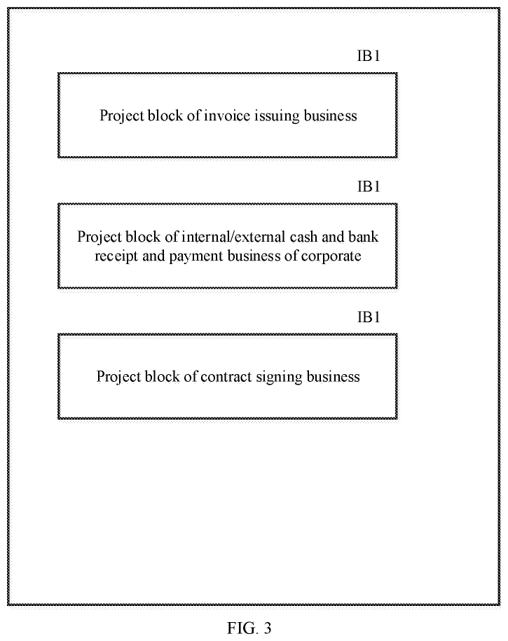

Referring to FIG. 3, FIG. 3 is a schematic diagram of a page providing the business agent of the corporate user to select a project block. For example, the corporate user may scan the corporate number and corporate code CC_Code through a two-dimensional code scanner of a mobile phone; after scanning the code, the mobile phone automatically links to a page, and the page displays a plurality of project blocks for the business agent to click, and the plurality of project blocks respectively correspond to a plurality of links of a plurality of businesses. As shown in FIG. 3, there are three project blocks IB1-IB3 in total, wherein the project block IB1 is a project block of invoice issuing business, the project block IB2 is a project block of internal/external cash and bank receipt and payment business of the corporate, and the project block IB3 is a project block of contract signing business.

In an embodiment, the plurality of business-specific seals BS1-BSp may include an invoice-specific seal, a financing-specific seal, a contract-specific seal and the like, but this is only an example and is not a limiting condition of the present invention. The invoice-specific seal is corresponding to the project block of the invoice issuing business, the financing-specific seal is corresponding to the project block of internal/external cash and bank receipt and payment business of the corporate, and the contract-specific seal is corresponding to the project block of the contract signing business.

In practice, when the business agent clicks a specific project block of the plurality of project blocks, a screen of the mobile phone may display a prompt message to remind the business agent to input a biometric datum. Next, the corporate number and corporate code management terminal apparatus 10 may judge whether the specific project block clicked by the business agent belongs to the business application range, and judge whether the biometric data input by the business agent are consistent with a registered biometric datum for authentication. When the specific project block clicked by the business agent belongs to the corresponding business application range, and the biometric data input by the business agent are consistent with the registered biometric datum, the business agent is allowed to call the electronic official seal ECS and the plurality of business-specific seals BS1-BSp in the business application range by means of the business authority. When the specific project block clicked by the business agent does not belong to the business application range, or the biometric data input by the business agent are not consistent with the registered biometric datum, the business agent is prohibited from calling the electronic official seal ECS and the plurality of business-specific seals BS1-BSp in the business application range by means of the business authority.

Please note that the corporate administrator and the business agent in the present invention represent different roles (positions) in the corporate, so different business authorities need to be configured. As shown in Table 1, the definition of the role of the corporate administrator is the top manager who manages the corporate number and corporate code in a single corporate, and the business authority level thereof is “All Authorities”, and there can only be one corporate administrator in a single corporate. The role of the business agent is defined as an operator of the corporate number and corporate code authorized by the corporate administrator in a single corporate, and the business authority level thereof is configured according to the business application scope of the business agent, and multiple business agents with the same or different business authorities can be generated in a single corporate according to actual needs. For example, business agent 1 may be a financial accountant, and the business application range thereof may include an invoice issuing business, and internal/external cash and bank receipt and payment business of the corporate. Business agent 2 may be a legal person, and the business application range thereof may comprise a contract signing business.

TABLE 1

| | Role | Business | |
|---|---|---|---|
| Role name | interpretation | authority level | Remarks |
| Corporate | Top manager who | All business | Legal person |
| administrator | manages a | authorities | automatically registers |
| | corporate number | | to become a corporate |
| | and corporate | | administrator, and one |
| | code in a single | | legal person can only |
| | corporate | | generate one piece of |
| | | | legal person information |
| | | | for this role. |
| Business agent 1 | Corporate number | Invoice issuing | According to the business |
| (financial accountant) | and corporate | business, and | application scope of the |
| | code operator | internal/external | business agent, |
| | authorized by the | cash and bank | corresponding business |
| | corporate | receipt and | authorities are |
| | administrator in | payment business | configured, and a |
| | a single | of the corporate | plurality of business |
| | corporate | | authorities can be |
| | | | generated |
| Business agent 2 | Corporate number | Contract signing | According to the business |
| (legal person) | and corporate | business | application scope of the |
| | code operator | | business agent, |
| | authorized by the | | corresponding business |
| | corporate | | authorities are |
| | administrator in | | configured, and a |
| | a single | | plurality of business |
| | corporate | | authorities can be |
| | | | generated |

In an embodiment, when the project block IB1 corresponding to the invoice issuing business is clicked by the business agent 1 and passes the authentication, the business agent 1 is allowed to call the electronic official seal ECS and the invoice-special seal; then, issue an electronic invoice according to the electronic official seal ECS, the invoice-specific seal and the business agent private seal BAS of the business agent 1. In another embodiment, when the project block IB3 corresponding to the contract signing business is clicked by the business agent 2 and passes the authentication, the business agent 2 is allowed to call the electronic official seal ECS and the contract-specific seal; then, sign an electronic contract according to the electronic official seal ECS, the contract-specific seal and the business agent private seal BAS of the business agent 2. On the contrary, if the authentication is not passed, the business agent is prohibited from calling the electronic official seal ECS and the plurality of business-specific seals BS1-BSp. For example, if the business agent 1 (financial accountant) clicks the project block IB3 corresponding to the contract signing business or the input biometric data are not consistent with the registered biometric data, the authentication is failed. In addition, the business administrator can click any project block and call the electronic official seal ECS and all business-specific seals BS1-BSp because he is configured with all business authorities.

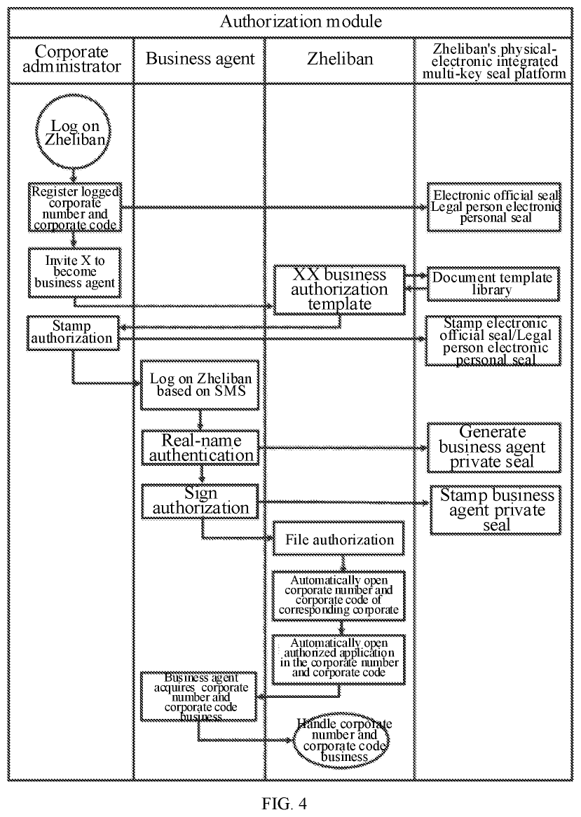

Referring to FIG. 4, FIG. 4 is a flow chart of authorization of the authorization module in an embodiment of the present invention. First, the corporate administrator logs in to the “Zheliban” APP to register and log in the corporate code. In this case, the electronic official seal and the legal person electronic personal seal of the corporate may be generated in the “Zheliban's physical-electronic integrated multi-key seal platform”. Next, the corporate administrator may invite X to be a business agent, and then “Zheliban” may build an XX business authorization template from a document template library of “Zheliban's physical-electronic integrated multi-key seal platform”. After the corporate administrator seals the authorization, an action of stamping the electronic official seal/legal person electronic personal seal of the corporate may be executed on “Zheliban's physical-electronic integrated multi-key seal platform”. In this case, the business agent may register and log in to “Zheliban” based on SMS. After real-name authentication, a business agent private seal may be generated on “Zheliban's physical-electronic integrated multi-key seal platform”, so that a business authority can be configured to the business agent. After that, when the business agent needs to sign an authorization, the business agent private seal may be stamped on “Zheliban's physical-electronic integrated multi-key seal platform”, and the authorization is filed in “Zheliban”. Next, “Zheliban” may automatically open the corporate number and corporate code of the corresponding corporate user and automatically open the authorized application in the corporate number and corporate code. After the business agent obtains the corporate number and corporate code, business processing relevant to the corporate number and corporate code may be completed in “Zheliban”.

It is worth noting that in this process, by setting different authorization templates for different business applications of “corporate number and corporate code” on the physical-electronic integrated multi-key seal platform (such as the corporate number and corporate code management terminal apparatus 10), the legal person who has already opened “corporate number and corporate code” can complete all the tasks assigned by quickly selecting the corresponding business, inputting the information of the business agent and directly signing the authorization. After that, the corporate number and corporate code management terminal apparatus 10 sends a short message to the business agent according to the authorized content (authorized business authority) and the information of the business agent, and the business agent visits and opens “Zheliban”. After a first visitor performs real-name authentication and registration (registered individual user directly), an authorization signing page pops up, and the business agent signs the authorization based on the business agent private seal, and the corporate number and corporate code management terminal apparatus 10 automatically opens the corporate number and corporate code for the business agent, and opens a business authority business function corresponding to the authorization.

Please note that the above biometric data may comprise fingerprint information data, iris information data and/or facial feature recognition data, or any biometric data that can identify users. In practical application, one or more of the data may be used for security identification.

The corporate number and corporate code management terminal apparatus of the present invention may be a trusted authentication server system or a third-party authentication platform system. This terminal apparatus comprises authentication, storage, management and application of various certificate keys such as electronic seals, and the terminal apparatus corresponds to any department or platform system of social transactions, comprising government, corporate and individual families.

The corporate number and corporate code management terminal apparatus of the present invention can be realized by a physical-electronic integrated intelligent electronic seal chip. The physical-electronic integrated intelligent electronic seal chip stores various certificates and keys, and all the certificates and keys can be distributed, downloaded, stored and applied remotely.

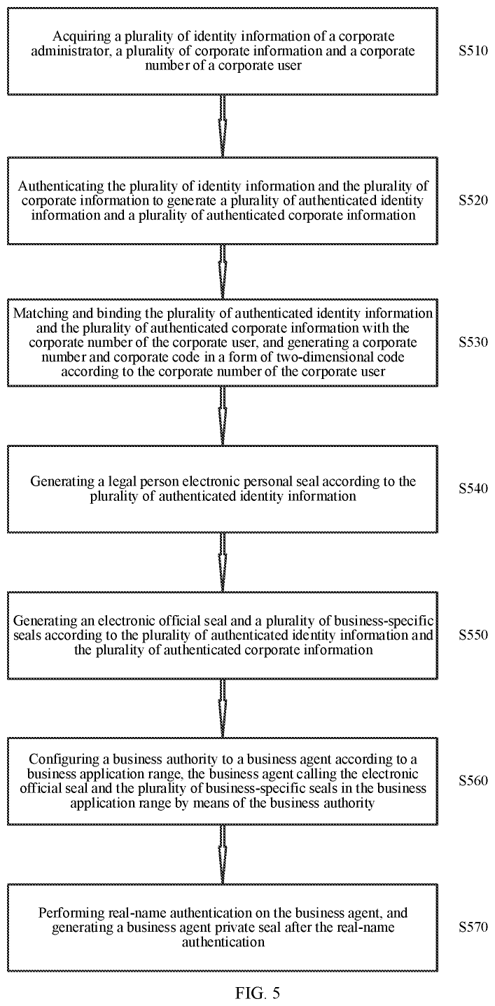

Referring to FIG. 1 and FIG. 5, FIG. 5 is a flow chart of a corporate number and corporate code management method in a first embodiment of the present invention.

The corporate number and corporate code management method in FIG. 5 comprises the following steps of:
Step S510: acquiring a plurality of identity information of a corporate administrator of a corporate user, and acquiring a plurality of corporate information and a corporate number of the corporate user.
Step S520: performing entity or digital authentication on the plurality of identity information and the plurality of corporate information to generate a plurality of authenticated identity information and a plurality of authenticated corporate information.
Step S530: matching and binding the plurality of authenticated identity information and the plurality of authenticated corporate information with the corporate number of the corporate user, and generating a corporate number and corporate code in a form of two-dimensional code according to the corporate number of the corporate user.
Step S540: generating a legal person electronic personal seal according to the plurality of authenticated identity information.
Step S550: generating an electronic official seal and a plurality of business-specific seals according to the plurality of authenticated identity information and the plurality of authenticated corporate information.
Step S560: configuring a business authority to a business agent according to a business application range, the business agent calling the electronic official seal and the plurality of business-specific seals in the business application range by means of the business authority.
Step S570: performing real-name authentication on the business agent, and generating a business agent private seal after the real-name authentication.

It should be noted that the step S510 is performed by the first capture module 110 and the second capture module 120, the step S520 is performed by the information authentication module 130, the step S530 is performed by the corporate number and corporate code generation module 140, the step S540 is executed by the legal person electronic personal seal generation module 150, the step S550 is executed by the electronic official seal and business-specific seal generation module 160, the step S560 is executed by the authorization module 170, and the step S570 is executed by the business agent private seal generation module 180.

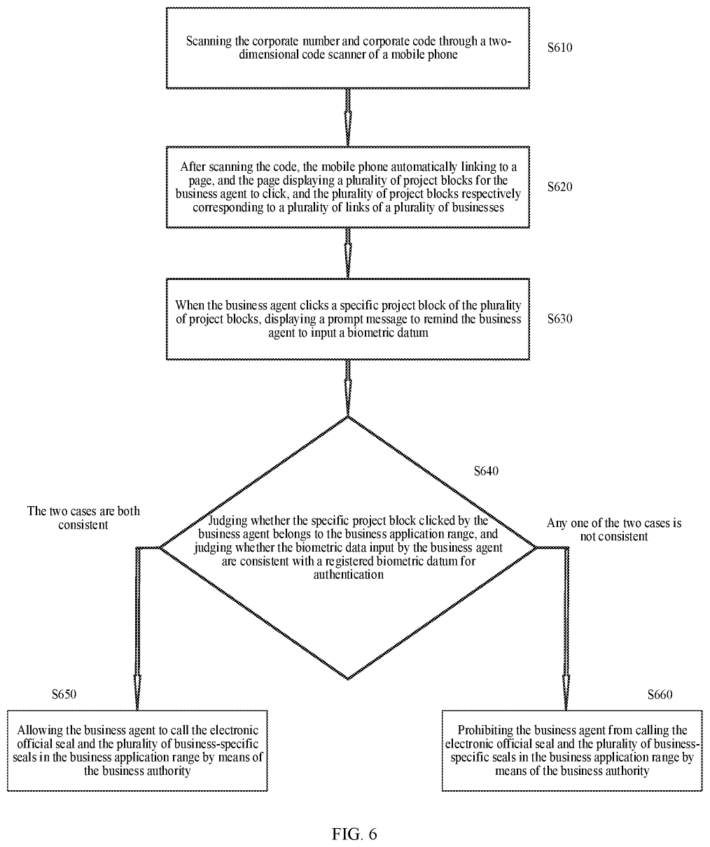

Referring to FIG. 6, FIG. 6 is a flow chart of a corporate number and corporate code management method in a second embodiment of the present invention. In addition to the steps of FIG. 5, the corporate number and corporate code management method of the present invention further comprises the following steps of:
Step S610: scanning the corporate number and corporate code through a two-dimensional code scanner of a mobile phone.
Step S620: after scanning the code, the mobile phone automatically linking to a page, and the page displaying a plurality of project blocks for the business agent to click, and the plurality of project blocks respectively corresponding to a plurality of links of a plurality of businesses.
Step S630: when the business agent clicks a specific project block of the plurality of project blocks, displaying a prompt message to remind the business agent to input a biometric datum.
Step S640: judging whether the specific project block clicked by the business agent belongs to the business application range, and judging whether the biometric data input by the business agent are consistent with a registered biometric datum for authentication.
Step S650: when the specific project block clicked by the business agent belongs to the business application range, and the biometric data input by the business agent are consistent with the registered biometric datum, allowing the business agent to call the electronic official seal and the plurality of business-specific seals in the business application range by means of the business authority.
Step S660: when the specific project block clicked by the business agent does not belong to the business application range, or the biometric data input by the business agent are not consistent with the registered biometric datum, prohibiting the business agent from calling the electronic official seal and the plurality of business-specific seals in the business application range by means of the business authority.

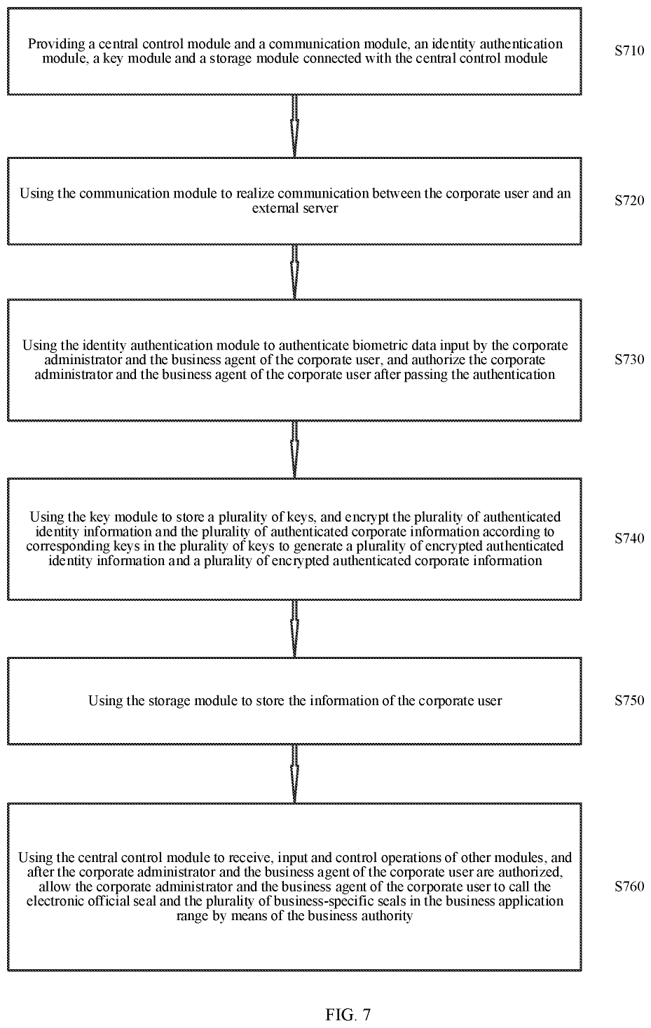

Referring to FIG. 2 and FIG. 7, FIG. 7 is a flow chart of a corporate number and corporate code management method in a third embodiment of the present invention. In addition to the steps of FIG. 5 and FIG. 6, the corporate number and corporate code management method of the present invention further comprises the following steps of:
Step S710: providing a central control module and a communication module, an identity authentication module, a key module and a storage module connected with the central control module.
Step S720: using the communication module to realize communication between the corporate user and an external server.
Step S730: using the identity authentication module to authenticate biometric data input by the corporate administrator and the business agent of the corporate user, and authorize the corporate administrator and the business agent of the corporate user after passing the authentication.
Step S740: using the key module to store a plurality of keys, and encrypt the plurality of authenticated identity information and the plurality of authenticated corporate information according to corresponding keys in the plurality of keys to generate a plurality of encrypted authenticated identity information and a plurality of encrypted authenticated corporate information.
Step S750: using the storage module to store the registered biometric data of the corporate administrator and the business agent of the corporate user, the plurality of encrypted authenticated identity information, the plurality of encrypted authenticated corporate information, the corporate number, the legal person electronic personal seal, the electronic official seal, the plurality of business-specific seals and the business agent private seal.
Step S760: using the central control module to receive, input and control operations of other modules, and after the corporate administrator and the business agent of the corporate user are authorized, allow the corporate administrator and the business agent of the corporate user to call the electronic official seal and the plurality of business-specific seals in the business application range by means of the business authority.

It should be noted that the step S720 is performed by the communication module 220, the step S730 is performed by the identity authentication module 230, the step S740 is performed by the key module 240, the step S750 is performed by the storage module 250, and the step S760 is performed by the central control module 210.

The specific embodiments of the present invention provide a corporate number and corporate code management method and a corporate number and corporate code management terminal apparatus, which can expand an application business mode authorized by the business agent on the basis of the application of the original ‘corporate code’. With regard to business agents of different titles, the present invention can configure different business authorities to the business agents according to the business application range, so that the business agents are allowed to call the electronic official seal ECS and the plurality of business-specific seals BS1-BSP in the business application range as long as passing dual authentications (one is the authentication that the biometric data are consistent and the other is the authentication that the business application range is consistent with the business authority), so as to handle daily businesses in a more convenient and efficient manner (for example: issuing an electronic invoice, and signing an electronic contract).

The embodiments of the present invention above may be implemented in various hardware, software codes or a combination of the two. For example, the embodiments of the present invention may also execute the program code of the above method in a Digital Signal Processor (DSP). The present invention may also relate to various functions performed by a computer processor, a digital signal processor, a microprocessor or a Field Programmable Gate Array (FPGA). According to the present invention, the above processors can be configured to perform specific tasks, which are accomplished by executing machine-readable software code or firmware code that defines the specific methods disclosed in the present invention. Software code or firmware code may be developed into different programming languages and different formats or forms. Software codes may also be compiled for different target platforms. However, different code styles, types and languages of software codes performing tasks according to the present invention and other types of configuration codes do not depart from the spirit and scope of the present invention.

The corporate number and corporate code management terminal apparatus of the present invention stores certificates and keys in a physical-electronic integrated intelligent electronic seal chip, rather than in a public platform, so that the privacy is strong and the security is high. Moreover, all the information is saved in a form of electronic keys, and then retrieved and used according to actual needs, which greatly improves the security of the certificates and the keys.

By means of the above technical solutions, the beneficial effects of the invention are as follows: compared with the prior art, the corporate number and corporate code management method and the corporate number and corporate code management terminal apparatus provided by the present invention expand the application business mode authorized by the business agent on the basis of the application of the original “corporate code”, not only can meet the actual demands of the daily government affair application of the corporate, but also can enable more corporate employees to directly, conveniently and efficiently use the corporate number and corporate code, which achieves an effective mode for quickly handling the government affair business of the corporate, and meanwhile, promotes and popularizes an application breadth and depth of the corporate number and corporate code more widely.

Specific examples are used herein to illustrate the principles and embodiments of the present invention. The description of the above embodiments is only used to help understand the methods and core ideas of the present invention. Meanwhile, for those of ordinary skills in the art, there will be changes in the specific implementation and application scope according to the idea of the present invention. To sum up, the contents of this specification should not be understood as limiting the present invention.

We claim:

1. A corporate number and corporate code management method, comprising the following steps of:
acquiring a plurality of identity information of a corporate administrator of a corporate user, and acquiring a plurality of corporate information and a corporate number of the corporate user;
performing entity or digital authentication on the plurality of identity information and the plurality of corporate information to generate a plurality of authenticated identity information and a plurality of authenticated corporate information;
matching and binding the plurality of authenticated identity information and the plurality of authenticated corporate information with the corporate number of the corporate user, and generating a corporate number and corporate code in a form of two-dimensional code according to the corporate number of the corporate user;
generating a legal person electronic personal seal according to the plurality of authenticated identity information;
generating an electronic official seal and a plurality of business-specific seals according to the plurality of authenticated identity information and the plurality of authenticated corporate information; and
configuring a business authority to a business agent according to a business application range, the business agent calling the electronic official seal and the plurality of business-specific seals in the business application range by means of the business authority.

2. The corporate number and corporate code management method according to claim 1, further comprising:
performing real-name authentication on the business agent, and generating a business agent private seal after the real-name authentication.

3. The corporate number and corporate code management method according to claim 1, wherein the plurality of corporate information comprise abound bank account number, an electronic business license, tax control information, an official seal number, a legal person certificate number, a social credit code and/or an electronic license number of the corporate user authorized by a banking system and/or a government system.

4. The corporate number and corporate code management method according to claim 1, wherein the corporate number comprises a mailbox number, a payment number, a cloud number, a video number and/or a fixed telephone number.

5. The corporate number and corporate code management method according to claim 2, wherein the plurality of business-specific seals comprise an invoice-specific seal, a financing-specific seal and a contract-specific seal.

6. The corporate number and corporate code management method according to claim 2, further comprising:
providing a central control module, and a communication module, an identity authentication module, a key module and a storage module connected with the central control module;
using the communication module to realize communication between the corporate user and an external server;
using the identity authentication module to authenticate biometric data input by the corporate administrator and the business agent of the corporate user, and authorize the corporate administrator and the business agent of the corporate user after passing the authentication;
using the key module to store a plurality of keys, and encrypt the plurality of authenticated identity information and the plurality of authenticated corporate information according to corresponding keys in the plurality of keys to generate a plurality of encrypted authenticated identity information and a plurality of encrypted authenticated corporate information;
using the storage module to store the registered biometric data of the corporate administrator and the business agent of the corporate user, the plurality of encrypted authenticated identity information, the plurality of encrypted authenticated corporate information, the corporate number, the legal person electronic personal seal, the electronic official seal, the plurality of business-specific seals and the business agent private seal; and
using the central control module to receive, input and control operations of other modules, and after the corporate administrator and the business agent of the corporate user are authorized, allow the corporate administrator and the business agent of the corporate user to call the electronic official seal and the plurality of business-specific seals in the business application range by means of the business authority.

7. The corporate number and corporate code management method according to claim 5, further comprising:
scanning the corporate number and corporate code through a two-dimensional code scanner of a mobile phone; and
after scanning the code, the mobile phone automatically linking to a page, and the page displaying a plurality of project blocks for the business agent to click, and the plurality of project blocks respectively corresponding to a plurality of links of a plurality of businesses.

8. The corporate number and corporate code management method according to claim 7, further comprising:
when the business agent clicks a specific project block of the plurality of project blocks, displaying a prompt message to remind the business agent to input a biometric datum;
judging whether the specific project block clicked by the business agent belongs to the business application range, and judging whether the biometric data input by the business agent are consistent with a registered biometric datum for authentication;
when the specific project block clicked by the business agent belongs to the business application range, and the biometric data input by the business agent are consistent with the registered biometric datum, allowing the business agent to call the electronic official seal and the plurality of business-specific seals in the business application range by means of the business authority; and
when the specific project block clicked by the business agent does not belong to the business application range, or the biometric data input by the business agent are not consistent with the registered biometric datum, prohibiting the business agent from calling the electronic official seal and the plurality of business-specific seals in the business application range by means of the business authority.

9. The corporate number and corporate code management method according to claim 8, further comprising:
when the specific project block clicked by the business agent is a project block corresponding to an invoice issuing business and passes the authentication, allowing the business agent to call the electronic official seal and the invoice-special seal; and
issuing an electronic invoice according to the electronic official seal, the invoice-specific seal and the business agent private seal of the business agent.

10. The corporate number and corporate code management method according to claim 8, further comprising:
when the specific project block clicked by the business agent is a project block corresponding to a contract signing business and passes the authentication, allowing the business agent to call the electronic official seal and the contract-specific seal; and
signing an electronic contract according to the electronic official seal, the contract-specific seal and the business agent private seal of the business agent.

11. A corporate number and corporate code management terminal apparatus, comprising:
a first capture module, used for acquiring a plurality of identity information of a corporate administrator of a corporate user;
a second capture module, used for acquiring a plurality of corporate information and a corporate number of the corporate user;
an information authentication module, coupled to the first capture module and the second capture module and used for performing entity or digital authentication on the plurality of identity information and the plurality of corporate information to generate a plurality of authenticated identity information and a plurality of authenticated corporate information;
a corporate number and corporate code generation module, coupled to the information authentication module and used for matching and binding the plurality of authenticated identity information and the plurality of authenticated corporate information with the corporate number of the corporate user, and generating a corporate number and corporate code in a form of two-dimensional code according to the corporate number of the corporate user;
a legal person electronic personal seal generation module coupled to the information authentication module and used for generating a legal person electronic personal seal according to the plurality of authenticated identity information;
an electronic official seal and business-specific seal generation module coupled to the information authentication module and used for generating an electronic official seal and a plurality of business-specific seals according to the plurality of authenticated identity information and the plurality of authenticated corporate information; and
an authorization module coupled to the electronic official seal and business-specific seal generation module, and used for configuring a business authority to a business agent according to a business application range, the business agent calling the electronic official seal and the plurality of business-specific seals in the business application range by means of the business authority.

12. The corporate number and corporate code management terminal apparatus according to claim 11, further comprising:
a business agent private seal generation module coupled to the authorization module and used for performing real-name authentication on the business agent, and generating a business agent private seal after the real-name authentication.

13. The corporate number and corporate code management terminal apparatus according to claim 12, further comprising a multi-module, wherein the multi-module comprises:
a central control module, and a communication module, an identity authentication module, a key module and a storage module connected with the central control module;
the communication module is used for realizing communication between the corporate user and an external server;
the identity authentication module is used for authenticating biometric data input by the corporate administrator and the business agent of the corporate user, and authorizing the corporate administrator and the business agent of the corporate user after passing the authentication;
the key module is used for storing a plurality of keys, and encrypting the plurality of authenticated identity information and the plurality of authenticated corporate information according to corresponding keys in the plurality of keys to generate a plurality of encrypted authenticated identity information and a plurality of encrypted authenticated corporate information;
the storage module is used for storing the registered biometric data of the corporate administrator and the business agent of the corporate user, the plurality of encrypted authenticated identity information, the plurality of encrypted authenticated corporate information, the corporate number, the corporate number and corporate code, the legal person electronic personal seal, the electronic official seal, the plurality of business-specific seals and the business agent private seal; and
the central control module is used for receiving, inputting and controlling operations of other modules, and after the corporate administrator and the business agent of the corporate user are authorized, allowing the corporate administrator and the business agent of the corporate user to call the electronic official seal and the plurality of business-specific seals in the business application range by means of the business authority.
